(19) United States
(12) Patent Application Publication
(10) Pub. No.: US 2010/0283978 A1
(43) Pub. Date: Nov. 11, 2010

(54) LED-based UV illuminators and lithography systems using same

(75) Inventor: Andrew M. Hawryluk, Los Altos, CA (US)

Correspondence Address: OPTICUS IP LAW, PLLC, 7791 ALISTER MACKENZIE DRIVE, SARASOTA, FL, 34240, US

(73) Assignee: ULTRATECH,INC.

(21) Appl. No.: 12/462,678

(22) Filed: Aug. 7, 2009

Related U.S. Application Data
(60) Provisional application No. 61/215,614, filed on May 7, 2009.

(51) Int. Cl. G03B 27/00; F21S 2/00

(52) U.S. Cl. 355/18; 250/494.1

(57) ABSTRACT

An LED-based UV illuminator is disclosed that includes a plurality of LED light sources that emit UV light, and a plurality of dichroic mirrors. The dichroic mirrors are arranged relative to the LED light sources and configured to direct the UV light along a common optical path. A light homogenizer, such as a light pipe, is arranged along the common optical path and acts to homogenize the UV light. The UV illuminator has a collection efficiency of greater than 50% and an illumination output equal to or greater than 850 mW/mm². Lithography systems that utilize the LED-based UV illuminator are also disclosed.

### CLAIM OF PRIORITY

This application claims the benefit of priority under 35 U.S.C. §119(e) of U.S. Provisional Application Ser. No. 61/215,614 filed on May 7, 2009, which application is incorporated herein by reference.

### FIELD OF THE INVENTION

The present invention relates generally to illuminators and lithography systems, and in particular to LED-based UV illuminators, and lithography systems using same.

### BACKGROUND ART

Current illuminators in ultraviolet-(UV-)wavelength lithography systems use either mercury (Hg) lamps or laser sources. Laser sources are used where shorter UV wavelengths of about 248 nm are needed, while mercury lamps are typically used for UV wavelengths between about 360 and 450 nm.

The emission from a mercury lamp must be matched to the etendue of the optical system (projection optics) used in the lithography system. The etendue is the product of the source size (mm²) and solid angle (steradians) and has units of mm²-steradians. This product is related to the “brightness” of the source (W/mm²-steradians). The etendue is conserved through the optical system. One cannot increase the etendue of a given source using optical means. By magnifying or demagnifying the source through optical means, one can change the source size and solid angle inversely, but the etendue remains constant.

To increase the throughput of a lithography system, the source brightness needs to be increased. This can be accomplished by increasing the power emitted from the source or by decreasing the etendue (i.e., decreasing the source size).

Increasing the power in a mercury lamp usually comes at the cost of increasing the source size. Doubling the output power generally requires doubling the source size. As a result, the effective brightness of the source remains approximately constant and the power density at the wafer plane remains constant. Throughput (i.e., wafers per hour) is generally not improved with these larger lamps. The larger power cannot be relayed to the wafer plane and cannot be converted into higher throughput. Decreasing the etendue while maintaining the emitted power is equally difficult to achieve. In general, decreasing the source size (etendue) also decreases the total power emitted.

### SUMMARY OF THE INVENTION

An aspect of the invention is a UV illuminator that makes efficient use of UV light-emitting diode (LED) light sources to provide efficient light collection and high illumination output.

Another aspect of the invention is a UV lithography system that includes a projection optical system and the LED-based UV illuminator of the present invention.

Another aspect of the invention is an LED-based UV illuminator that uses dichroic mirrors to integrate UV light (i.e., UV radiation) emitted by multiple UV LED light sources, such as LED arrays made up of LED elements.

Another aspect of the invention is an LED-based UV illuminator that uses dichroic mirrors and one or more light “homogenizers such as light pipes to integrate UV light emitted by multiple UV LED light sources in the form of LED arrays.

Another aspect of the invention is an LED-based UV illuminator configured to match the source size and divergence of LED arrays to achieve >50% collection efficiency of the LED light emitted by the LED arrays.

Another aspect of the invention is an LED-based UV illuminator that uses multiple light homogenizers to distribute the heat load from the UV LED light sources by separating the UV LED light sources.

Another aspect of the invention is an LED-based UV illuminator that provides an illumination output of greater than about 850 mW/mm², which yields an illumination of about 600 mW/mm² at the wafer plane of a UV lithography system that has about a 70% transmission from the reticle plane to the wafer plane.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a schematic diagram of an example UV lithography system in which the LED-based UV illuminator of the present invention is suitable for use;

FIG. 2 is a schematic diagram of an example illumination field and an example exposure field associated with the UV lithography system of FIG. 1;

FIG. 3 is a plan view of a semiconductor wafer with exposure fields formed thereon by the UV lithography system of FIG. 1;

FIG. 4 illustrates an example embodiment of a LED-based UV illuminator;

FIG. 5 is a schematic diagram of a UV LED light source in the form of an array of individual UV LED elements;

FIG. 6A and FIG. 6B are schematic diagrams of an example embodiment of an LED-based UV illuminator that includes bulk dichroic mirrors in combination with a separate light homogenizer;

FIG. 7 is a schematic diagram of the example UV illuminator that combines two of the illuminators of FIG. 4;

FIG. 8 is a close-up view of two UV LED light sources having corresponding LED emission regions that are combined via lenses to form a larger LED emission region;

FIG. 9 is similar to FIG. 8 and shows an example where UV LED light sources are combined from four directions to form a combined LED emission region; and

FIG. 10 and FIG. 11 are schematic diagrams that illustrate example configurations for LED elements within an LED array and the associated electronics/cooling units for each LED element.

### DETAILED DESCRIPTION OF THE INVENTION

Reference is now made in detail to the present preferred embodiments of the invention, examples of which are illustrated in the accompanying drawings. Whenever possible, the same reference numbers and symbols are used throughout the drawings to refer to the same or like parts. Cartesian X-Y-Z coordinates are shown in the Figures for reference.

The present invention is directed to illuminators and lithography systems, and in particular to LED-based UV illuminators and UV lithography systems using same. A generalized UV lithography system is first described, followed by detailed example LED-based UV illuminators suitable for use in such a lithography system.

U.S. Pat. No. 5,852,693 entitled “Low Loss Light Redirection Apparatus,” is incorporated by reference herein.

### UV Lithography System

An example embodiment of the invention is a UV lithography system that uses the LED-based UV illuminator of the present invention. Example UV lithography systems in which the LED-based illuminator of the present invention can be adapted for use are described in U.S. Pat. Nos. 7,177,099; 7,148,953; 7,116,496; 6,863,403; 6,813,098; 6,381,077; and 5,410,434, which patents are incorporated by reference herein in their entirety.

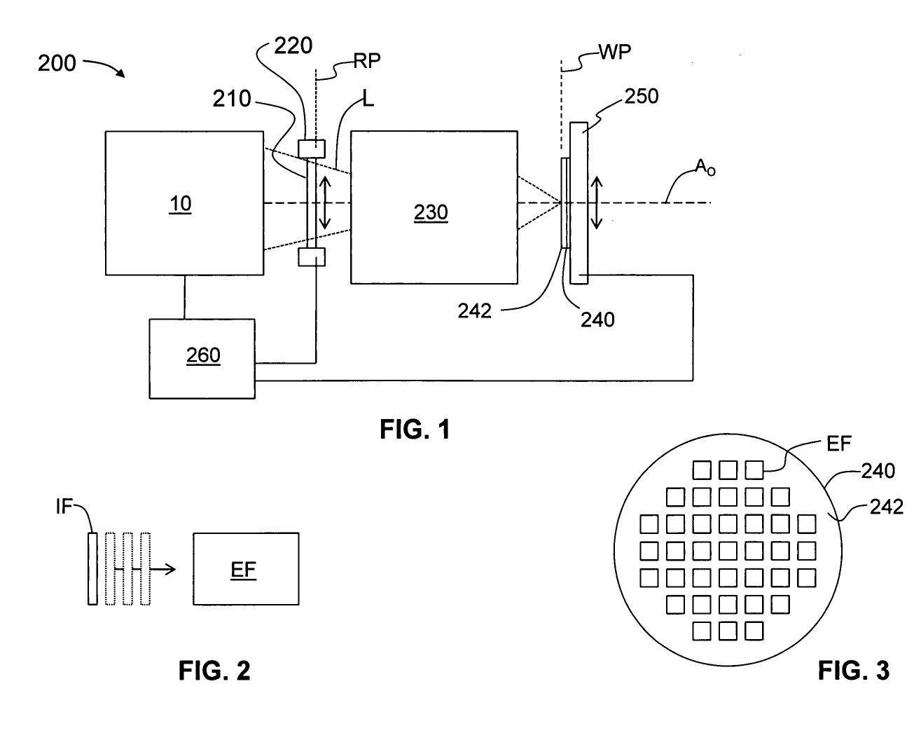

FIG. 1 is a schematic diagram of an example UV lithography system 200 in which the LED-based illuminator of the present invention is suitable for use. UV lithography system 200 includes, along an optical axis A_{O}, an LED-based UV illuminator 10 of the present invention, a reticle 210 (e.g., a patterned mask) supported by a reticle stage 220 at a reticle plane RP, projection optics 230, and a wafer 240 supported by a wafer stage 250 at a wafer plane WP. System 200 also includes a controller 260 operably connected to UV illuminator 10, reticle stage 220 and wafer stage 250 and configured to control the operation of system 200. Reticle stage 220 and wafer stage 250 are movable so that an imaging field IF (which is the image of the illuminated portion of reticle 210 formed at wafer plane WP by projection optics 230) can be placed at different parts of wafer 240 to form various exposure fields EF on the wafer. Wafer 240 includes a photosensitive coating 242 (e.g., photoresist) that is activated by the UV light (“actinic light) L generated by UV illuminator 10.

UV light L from UV illuminator 10 is used to illuminate either a portion of reticle 210 or the entire reticle. Reticle 210 is then imaged onto photosensitive surface 242 of wafer 240 via projection optical system 230. In an example embodiment, reticle 210 and wafer 240 are moved together in a manner that scans imaging field IF over the wafer to form an exposure field EF that is larger than the imaging field, as illustrated in FIG. 2. With reference to FIG. 3, exposure fields EF formed on wafer 240 are in turn used to form integrated circuit chips via standard photolithographic and semiconductor processing techniques.

There are certain basic power requirements for UV lithography system 200, depending on the size of imaging field IF. For an imaging field IF of 15 mm×30 mm, which has an area of 4.5 cm², approximately 750 to 1500 mW/mm² needs to be delivered to wafer plane WP in each of the g-line and h-line wavelength bands (i.e., 405 nm and 450 nm, respectively) and 250 to 750 mW/mm² in the i-line wavelength band (i.e., 365-375 nm). Assuming that illuminator 10 is configured to collect 65% of UV light L from the UV LED sources and 70% optical transport efficiency so that 45% of the total LED emission makes it to wafer plane WP, the UV LED light sources need to emit 7.5 W to 15 W at each of the g-line and h-line, and 2.5 W to 7.5 W at the i-line.

For the g-line and h-lines, consider four UV LED light sources 12 (two for the g-line and two for the h-line). To obtain ˜10 W of output power in each line, one needs about 5 W from each UV LED light source 12. For the i-line, consider two UV LED light sources 12. To obtain ˜5 W of output power, one needs about 2.5 W from each UV LED light source 12.

For an imaging field IF of 26 mm×68 mm, which has an area of 17.7 cm², approximately 750 to 1500 mW/mm² needs to be delivered to wafer plane WP in each of the g-line and h-line bands, and need approximately 250-750 mW/mm² of 365 to 375 nm radiation. Assuming again that 45% of the total LED emission makes it to wafer plane WP, the UV LED light sources need to emit 30 to 60 W at each of the g-line and h-line, and 10 to 30 W at the i-line.

For the g-line and h-line, consider four UV LED light sources 12 (two for the g-line and two for the h-line). To obtain about 50 W of output power, about 25 W from each UV LED light source 12 is needed. For the i-line, consider two UV LED light sources 12. To obtain about 20 W of output power, about 10 W from each UV LED light source 12 is needed.

In an example embodiment, UV illuminator 10 of the present invention has an output at its output end that is equal to or greater than about 850 mW/mm². This yields an illumination of about 600 mW/mm or greater at wafer plane WP of UV lithography system 200 assuming about a 70% transmission from the reticle plane RP to the wafer plane WP.

### LED-Based UV Illuminator

During the past decade, the efficiency of LEDs (in terms of lumens/W) has increased 10-fold and is expected to increase by a factor of between 2× and 4× within the next 5 years. As LED efficiency improves, their brightness increases. LEDs are now approaching emissions of 1 W/mm². Unfortunately, LEDs still are still inefficient in the sense that for every watt of LED power emitted, approximately 3-10 W (depending upon the wavelength) is dissipated through heat. This heat dissipation makes it difficult to tightly package multiple LEDs. Yet, in connection with using LEDs in illuminators for UV lithography systems, only a fraction of the emitted light from an LED falls within the solid angle of projection optical system 230. This implies that multiple, closely packed LEDs are needed to meet the lithography system's exposure requirements. Yet, the heat dissipation issue makes closely packing the multiple LEDs problematic.

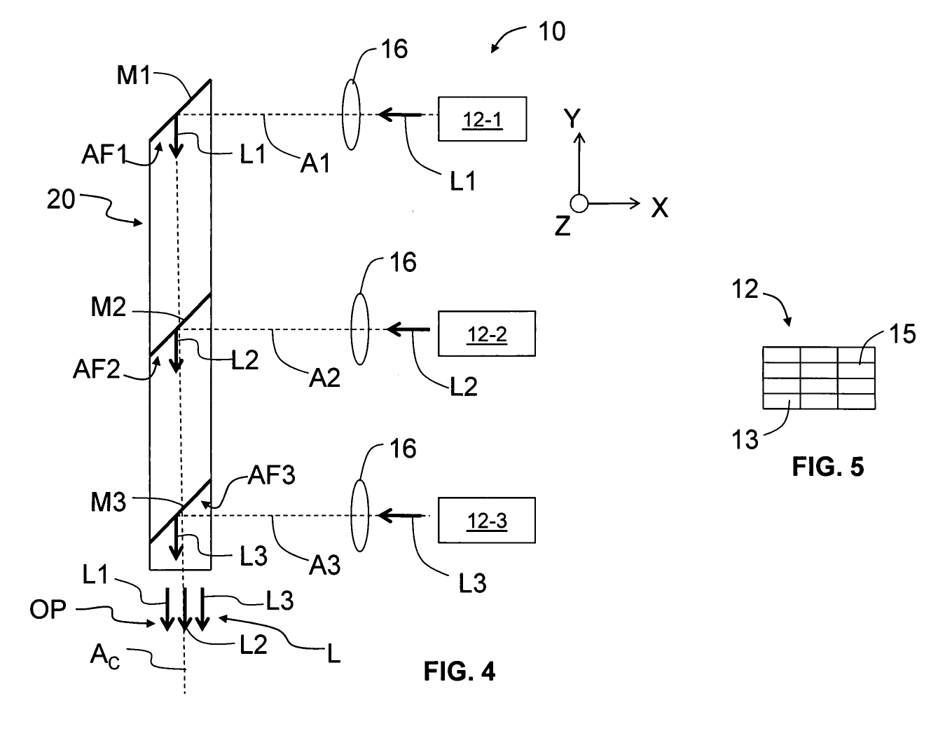

FIG. 4 illustrates an example embodiment of a LED-based UV illuminator (“UV illuminator”) 10. UV illuminator 10 includes a light homogenizer 20. Example light homogenizers 20 include light pipes made of solid glass material such as quartz, light tunnels that are hollow and that have reflective inner sidewalls, microlens arrays, diffusers and the like. Light homogenizer 20 of FIG. 4 is shown as a light pipe by way of example.

UV illuminator 10 also includes multiple UV LED light sources, such as UV LED light sources 12-1, 12-2 and 12-3 that respectively emit UV LED light L1, L2 and L3 at respective wavelengths λ₁, λ₂ and λ₃ and along respective optical axes A1, A2 and A3. In an example embodiment, wavelengths λ₁, λ₂ and λ₃ are the center wavelengths of respective wavelength bands Δλ₁, Δλ₂ and Δλ₃ emitted by respective UV LED light sources 12-1, 12-2 and 12-3. Example UV LED light sources 12 include UV LED arrays.

FIG. 5 is a schematic diagram of a UV LED light source 12 in the form of an array of individual UV LED elements (“LEDs”) 13. The sizes of LEDs 13 can vary. Typical LEDs range in size from 1×1 mm to 1.5×1.5 mm, while some are available at 2×2 mm. LED arrays typically have some “dead space” 15 between the individual LEDs 13. The collection of this “dead” space constitutes a non-emitting region 15, so that the LED emitting region 30 needs to emit more radiation to obtain the required power levels at wafer plane WP of UV lithography system 200. Typical LED arrays have about ½ mm spacing between LED chips in their package. For 1×1 mm square LED chips, the fractional percentage of the LED array non-emitting region 15 compared to the emitting region 30 is about 33%. Thus, in an example embodiment of UV LED light sources 12 in the form of an array of LEDs 13, the LEDs are larger than 2×2 mm and have a spacing of about 0.1 mm or less, so that the fractional percentage of non-emitting region 15 is less than 5% and preferably less than 3% as compared to emitting region 30.

With the 15×30 mm imaging field IF and a 5× magnification of the UV LED sources 12, an exemplary UV LED light source has an array size of 3 mm×6 mm. For LEDs 13 measuring 3×3 mm, the 3 mm×6 mm UV LED light source can be formed by combining two such LEDs. For LEDs measuring 1×1 mm, UV LED light source 12 can be formed by an array of eighteen LEDs arranged, for example, in a 3×6 array For the 26 mm×68 mm imaging field IF, and still using 5× magnification, UV LED light source 12 has a size of 5.2 mm×13.6 mm. For this configuration, an example UV LED light source 12 is formed by a 3×3 array to form a 6 mm×15 mm LED array, with a magnification of about 4.5× provided by lenses 16 (introduced and discussed below).

In an example embodiment, the following wavelength bands Δλ are generated by UV LED light sources 12: Δλ₁: 360 nm to 380 nm; Δλ₂: 390 nm to 410 nm; and Δλ₃: 420 nm to 450 nm. Also in an example embodiment, the LED wavelengths λ include at least one wavelength below 300 nm, such as 240 nm.

Light homogenizer 20 includes dichroic mirrors M1, M2 and M3 arranged relative to respective axes A1, A2 and A3 and respectively configured (e.g., via coatings on the angled facets AF of the light pipe) to efficiently collect and combine light L1, L2 and L3 from UV LED light sources 12-1, 12-2 and 12-3. In an example embodiment, lenses 16 are arranged along respective axes A1, A2 and A3 to assist in collecting UV LED light L1, L2 and L3. In an example embodiment, lenses 16 have one or more lens elements and in some cases have an associated magnification. In an example embodiment, lenses 16 include at least one mirror. In an example embodiment, lenses 16 are used to magnify the LED emission region by a select amount to provide an imaging field IF of a select size. In an example embodiment where UV LED light source 12 is constituted by an array of UV LEDs 13, lens 16 is or includes a microlens array. An example range of the magnitude of optical magnification of lenses 16 is between 2× and 10×.

In an example embodiment, UV light L1, L2 and L3 is respectively collected by mirrors M1, M2 and M3 and combined along a common optical path OP, e.g., along an axis A_{C} in a given direction. The UV light L1, L2 and L3 need not be completely overlapping along the common optical path OP, and in example embodiments are “side by side” within the common optical path, or are partially (spatially) overlapping within the common optical path. Light homogenizer 20 serves to integrate (i.e., uniformized) the emission of the multiple UV LED light sources 12 without increasing the etendue.

The number of UV LED light sources 12 and wavelengths λ is limited only by optical coating technology. The dichroic mirrors M transmit one wavelength band Δλ_{T} and reflect another wavelength band Δλ_{R}. For example, mirror M2 transmits wavelength band Δλ₁ and reflects wavelength band Δλ₂. The angular spread of the light L1, L2, . . . from the different UV LED light sources 12-1, 12-2, . . . needs to be taken into account in mirrors M. Typically, coating technology requires that wavelength bands Δλ₁, Δλ₂ and Δλ₃ associated with each UV LED light source 12 to be separated by several nanometers.

In an example embodiment, LED lights sources 12-1, 12-2 and 12-3 operate at respective wavelengths λ₁ in the i-line range of 365 nm to 375 nm, λ₂ of nominally 405 nm (h-line) and λ₃ of nominally 440 to 450 nm (g-line). An example UV illuminator 10 having more selective dichroic mirrors M1, M2 and M3 allows the number of UV LED light sources and wavelengths to increase, and includes wavelengths such as 375 nm, 390 nm, 405 nm, 420 nm and 440 nm. By adding additional wavelengths, the illuminator brightness is increased, but the etendue remains the same. In an example embodiment, UV LED light sources 12 that emit at wavelengths less than 300 nm are employed, e.g., at a wavelength of nominally 240 nm.

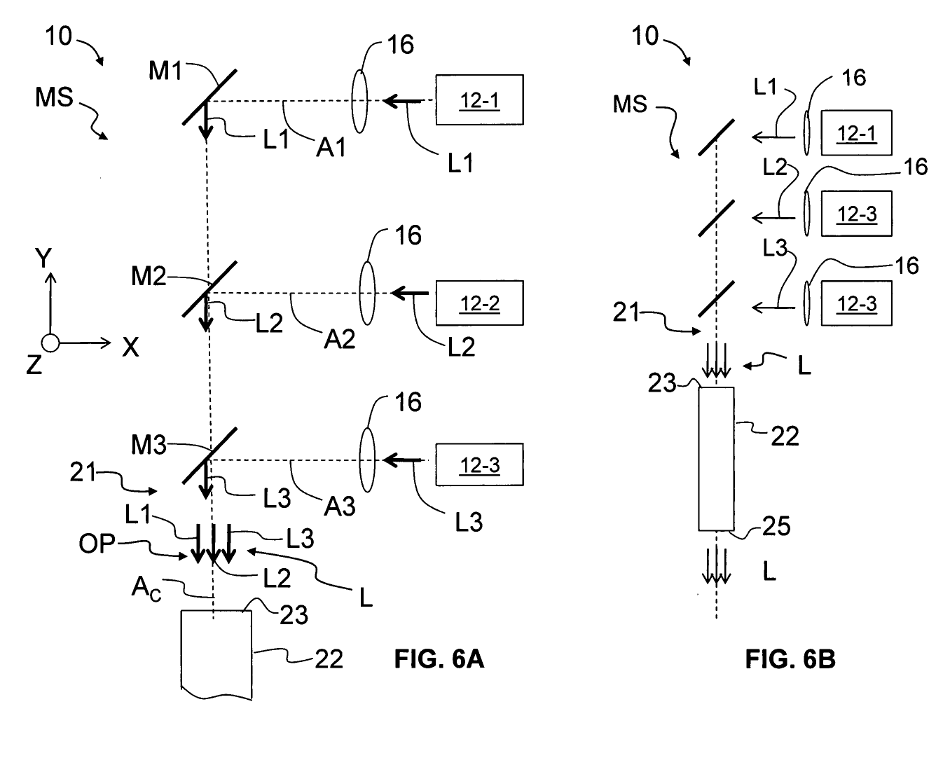

FIG. 6A and FIG. 6B show an example UV illuminator 10 similar to FIG. 1 but that utilizes bulk dichroic mirrors M1, M2 and M3 that constitute a mirror system MS. In this configuration, UV light L1, L2 and L3 propagates through free-space rather than through the length of a glass light homogenizer 20. Also in this configuration, lenses 16 image the output of the UV LED light sources 12 array directly onto an input end 23 of a homogenizer rod 22. Uniformized UV light L exits the output end 23 of homogenizer rod 22. This configuration has the advantage that the dichroic mirrors M are stand alone entities rather than incorporated into the angled facets of a light-pipe integrator. However, this configuration requires a separate homogenizer rod 22 or other light homogenizer arranged at an output end 21 of mirror system MS and so can render the UV illuminator 10 less compact than when the mirrors are combined with the light homogenizer.

The UV illuminator 10 of the present invention integrates the output of several (e.g., two to eight, or more) UV LED light sources 12 (e.g., LED arrays) in a manner that results in efficient illumination for UV lithography system 200 while also controlling thermal management issues associated with LED heat dissipation. In example embodiments, over 50% of the light from the LEDs is collected and judiciously combined to achieve the necessary brightness and illumination uniformity required for the UV lithography system.

UV illuminator 10 separates the overall LED emission (i.e., UV light L) into a number of UV LED light sources, which are preferably configured as arrays of individual LEDs 13 such as shown in FIG. 5. Each UV LED light source 12 has a size and an output power that is thermally managed. Each UV LED light source 12 is optically magnified and relayed by lenses 16 onto or into light homogenizer 20 (which may be solid or hollow), or onto a common optical path formed by dichroic mirrors M. By magnifying the output of each UV LED light source 12, a large fraction (e.g., greater than 50%) of the overall UV light L is collected. UV illuminator 10 allows for a large number of UV LED light sources 12 to be combined (integrated) into one “effective source” without increasing the effective etendue of the source.

UV LED light sources 12 typically emit in a Lambertian pattern so that there is a strong Cosine emission dependence. For optical systems (such as projection optics 230 of UV lithography system 200) having finite numerical apertures (NA), only light emitted within the object-side or “reticle-side” NA of the projection optical system will be collected and used. If no light-conditioning optics are used in UV illuminator 10, only the UV light L emitted by the LED within the collection solid angle of projection optics 230 is collected. For a Lambertian source, the amount of light collected within a specific solid angle is approximately equal to (NA)^{2.} For a projection optical system object-side NA=0.16, only 2.5% of UV light L emitted by UV LED light sources 12 is captured.

By magnifying UV LED light sources 12 using lenses 16, the LED emission pattern of UV light L is substantially matched to the object-side NA of projection optical system 230. The emitted radiation pattern is scaled through the optical magnification of lenses 16. LEDs 13 generally have an emission region that is much smaller than the exposure field EF of a UV lithography system 200. By optically magnifying the size of the UV LED light sources 12 to substantially match the size of the lithography system imaging field IF, the emission cone angle of the UV LED light source is effectively reduced by the magnification factor. Hence, from the same UV LED light source 12, it becomes possible to capture much more UV light L within the projection optical system's limited NA. For example, by magnifying the UV LED light source by 5× (and hence, reducing the cone angle by the same 5×), the amount of UV light L1, L2, . . . collected from each UV LED light source 12 (i.e., 12-1, 12-2, . . . ) increases from 2.5% to 64%.

An example UV illuminator 10 is now considered based on example requirements of a 1:1 lithography system of NA=0.16 and having the two aforementioned sizes of imaging fields IF. The first imaging field size considered is 15 mm×30 mm. For this example, the integration of three different LED wavelengths is considered: λ₁=375 nm, λ₂=405 nm and λ₃=440 nm. UVLED light sources 12 that emit at these wavelengths are commercially available from a variety of vendors, such as Nichia (Japan) and SemiLEDS (US).

In one example, UV LED light sources 12 are combined (integrated) using the simple dichroic mirror approach of FIG. 6, while in another example light homogenizer 20 having dichroic coatings on angled facets AF that serve as mirrors M is used, as illustrated in FIG. 4.

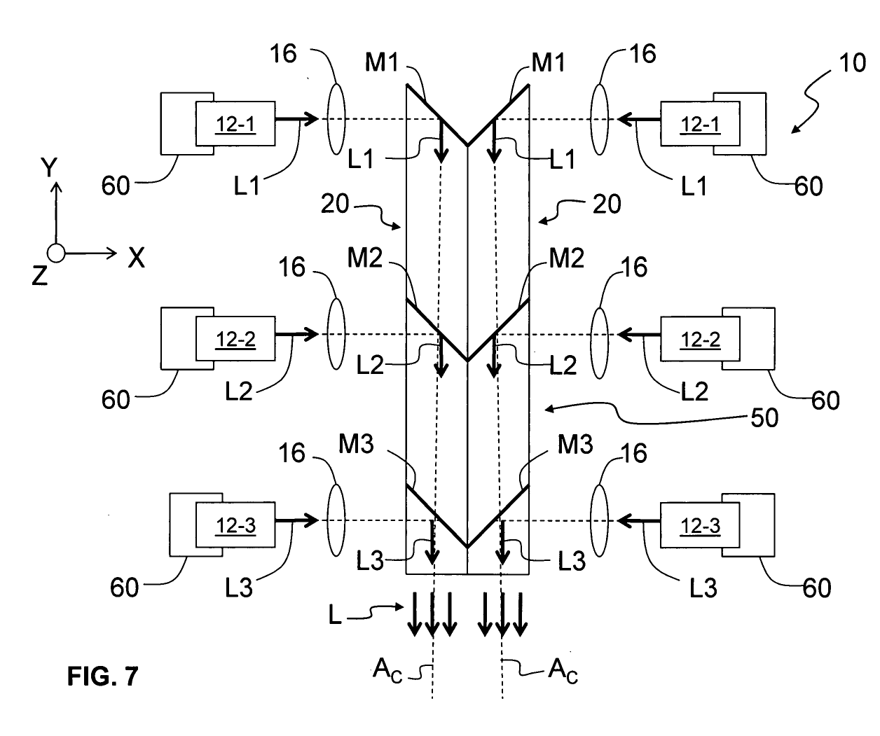

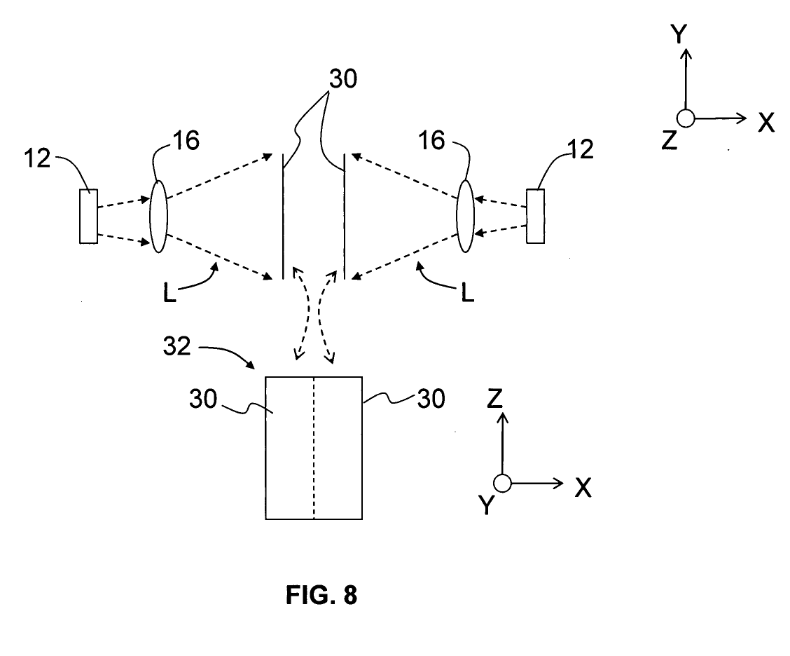

FIG. 7 is a schematic diagram of an example UV illuminator 10 that combines two of the illuminators of FIG. 4 in a side-by-side configuration (with one reflected over the other) in the manner shown. With reference to FIG. 8, each UV LED light source 12 has a corresponding LED emission region 30, which are combined to form a combined or effective LED emission region 32 (which is in the X-Z plane). In the example 1:1 lithography system illuminator 10, the size of the LED emission region 30 is roughly 1.5 mm wide by 7 mm long. The emission pattern from UV LED light sources 12 is roughly Lambertian. Taken by itself, only a small fraction (2.5%) of the emitted UV light L is within the solid angle of the 1:1 lithography system (not shown), so that 97.5% of the emitted UV light L would be rejected, which is unacceptably inefficient.

To overcome this deficiency, each LED emission region 32 is magnified by 5× via the operation of respective lenses 16, so that the projected area associated with LED emission region 30 is roughly 7.5 mm×30 mm in size, which substantially matches the cross-sectional dimensions of the associated light homogenizer 20. The amount of this UV light L that falls within the NA of the 1:1 lithography system is roughly 64%. Hence, 64% of the UV light L1, L2, . . . from each UV LED light source 12-1, 12-2, . . . is collected and used.

The combination of two light homogenizers 20 forms a light homogenizer assembly 50 that produces a combined LED emission field 32 matched to the size of the 30 mm×15 mm imaging field IF of example 1:1 UV lithography system 200. The advantage of this UV illuminator design is that one is able to integrate multiple UV LED light sources 12 at the same and at different wavelengths λ without increasing the source etendue. At the same time, the thermal management (i.e., heating of the UV LED light sources 12) is handled by having multiple UV LED light sources that are individually operated and controlled by electronics/cooling units 60 operably arranged relative to the respective UV LED light sources. Electronics/cooling units 60 include electronics to operate LEDs 13 making up UV LED light source 16 and also include cooling devices configured to remove heat from the LEDs.

Approximately 50 to 75% of the power driving the typical LED 13 is dissipated as heat. In one example embodiment, electronics/cooling units 60 provide cooling via conduction to a heat sink, wherein the heat sink itself is either air-cooled for lower-power LEDs or water-cooled for higher power LEDs.

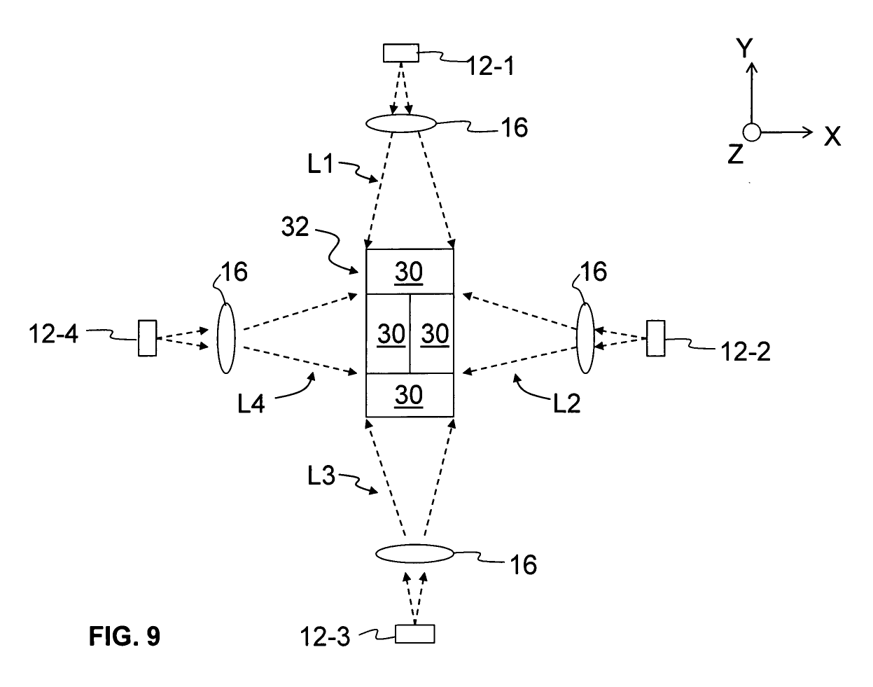

The example UV illuminator 10 of FIG. 7 has a light homogenizer assembly 50 with UV LED light sources 12 converging from two directions (i.e., the +X and −X directions). FIG. 9 is schematic diagram of a portion of an example light homogenizer assembly 50 illustrating an example embodiment wherein the UV LED light sources 12 converge from left, right, front and back (i.e., four directions: +X, −X, +Y and −Y) to increase the amount of optical power delivered by UV illuminator 10. The combined UV LED emission field 32 is shown in FIG. 9 as it appears in the X-Z plane.

The example four-directional UV illuminator configuration is used to more efficiently match the optical and physical properties of the UV LED light sources 12. For example, it may be difficult to fabricate UV LED light sources 12 in certain closely packed configurations that yield the required LED emission region 30 due to cost or thermal management issues. Under such conditions, it may be more effective to separate the UV LED light sources 12 into smaller units and integrate them as shown FIG. 9.

As discussed above, example power requirements for 15 mm×30 mm imaging field IF for a present-day UV lithography system 200 are as follows:

1) Greater than 1500 mW/mm² of energy between 400 and 450 nm

2) Greater than 250 mW/mm² of energy between 365 and 375 nm

The image field size of 15 mm×30 mm defines the total power P (greater than 6.75 W between 400 and 450 nm, and greater than 1.1 W between 365 and 375 nm) delivered to wafer 240 in the 1:1 lithography system 200. Assuming that 70% of the light collected by the light homogenizer assembly 50 is delivered to wafer plane WP (with 30% being lost due to optical transport inefficiencies), and assuming 64% of the UV LED light L is collected (using the 5× magnifying microlens arrays 16), it is estimated that the UV LED light sources 12 in the illuminator configuration of FIG. 7 need to emit approximately 500-1000 mW/mm².

In an example embodiment of a 26 mm×68 mm imaging field IF, each light homogenizer 20 in light homogenizer assembly 50 has a 13 mm×68 mm cross-section in the X-Z plane. Each UV LED light source 12 has an LED emission region 30 of 2.5 mm×13 mm.

As with the case for a 15×30 mm imaging field IF for the example 1:1 lithography system 200, each UV LED light source 12 is magnified 5× using a microlens array 16. This allows UV illuminator 10 to collect roughly 64% of the UV LED array emission. The LED emission region 30 is magnified by respective lenses 16 to be 12.5 mm×65 mm, which is slightly less than the light homogenizer segment cross-sectional dimensions of 13 mm×68 mm. It is preferable to keep the size of the UV LED light source image smaller than the light homogenizer X-Z dimensions so that no light is lost. As with the 15 mm×30 mm imaging field IF, two individual light homogenizers 20 (each 13 mm×68 mm in size) are combined to form light homogenizer assembly 50 that illuminates an area in the X-Z plane having dimensions of 26 mm×68 mm.

The lithography power density requirements for a 26 mm×68 mm imaging field are similar to those for the aforementioned 15 mm×30 mm imaging field. However, since the imaging field IF is larger, the total power requirements scale with the area. Between wavelengths of 400 nm and 450 nm, greater than 26 W of light is required at wafer plane WP. For wavelengths between 365 and 375 nm, greater than 4.5 W of power is required at wafer plane WP. In this design, the source area (i.e., the LED emission region 30) is scaled along with the size of image field IF. Thus, the emission requirements from the UV LED light sources 12 remain the same as in the 15 mm×30 mm case, namely 500-1000 mW/mm².

Embodiments of the LED-based UV illuminator 10 include integrating LED arrays from one or more directions, such as between one and four directions. Embodiments also include integrating multiple LED emission wavelengths λ. While certain example embodiments set forth above show only three UV wavelengths by way of illustration, the number of LED wavelengths λ is only limited by coating technology for dichroic mirrors. As dichroic mirror technology improves, it will be possible to integrate an increasing number of wavelengths λ.

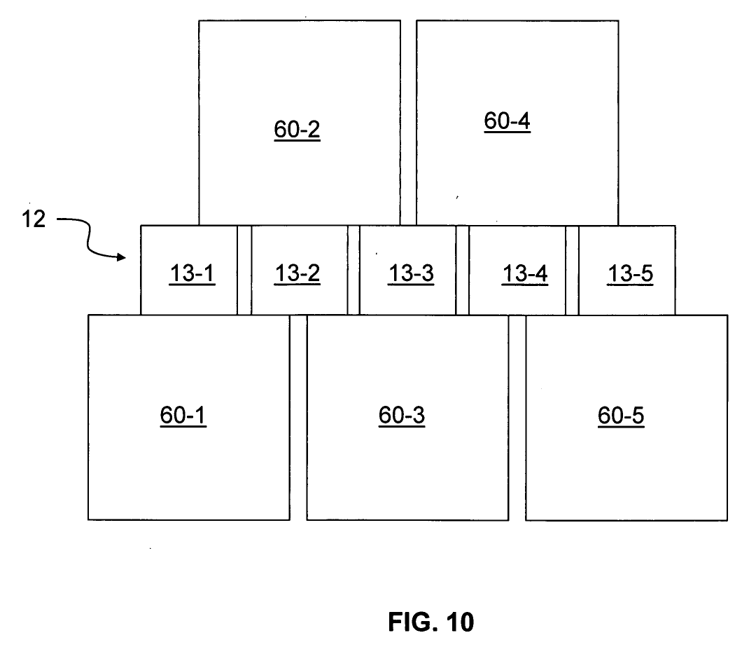

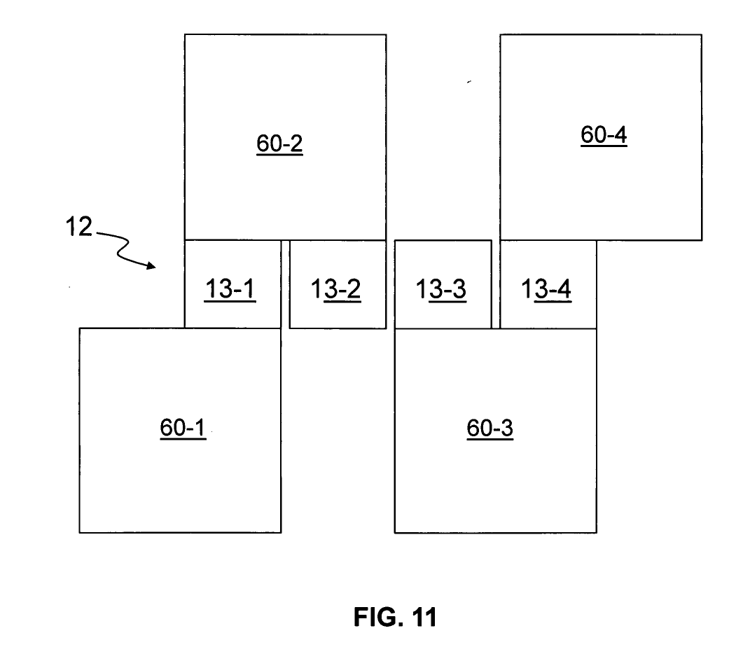

FIG. 10 is a schematic diagram illustrating an example embodiment of how individual LEDs 13-1, 13-2, . . . 13-5 are configured relative to respective individual electronics/cooling units 60-1, 60-2, . . . 60-5 within an individual UV LED light source 12 configured as an LED array. FIG. 11 is similar to FIG. 10 and illustrates another configuration for four individual LEDs 13-1, 13-2, 13-3 and 13-4 and corresponding electronics/cooling units 60-1, 60-2, 60-4 and 60-4.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A light-emitting diode-(LED)-based ultraviolet (UV) illuminator system, comprising:
a plurality of LED light sources that emit UV light;
a plurality of dichroic mirrors arranged relative to the LED light sources and configured to direct the UV light along a common optical path;
a light homogenizer having an output end and arranged along the common optical path and that acts to homogenize the UV light from the plurality of LED light sources and output homogenized light the output end; and
wherein the UV illuminator has a collection efficiency of greater than 50% and an illumination output of equal to or greater than 850 mW/mm².

2. The illuminator system of claim 1, wherein the light homogenizer includes a light pipe and the dichroic mirrors are formed on angled facets of the light pipe.

3. The illuminator system of claim 1, wherein at least one of the UV LED light sources comprises an array of LED elements.

4. The illuminator system of claim 1, including at least first, second and third UV LED light sources that respectively emit radiation in the following wavelength bands: Δλ₁ from 360 nm to 380 nm; Δλ₂ from 390 nm to 410 nm; and Δλ₃ from 420 nm to 450 nm.

5. The illuminator system of claim 1, wherein the dichroic mirrors are bulk dichroic mirrors.

6. The illuminator system of claim 1, wherein the light homogenizer includes at least one of: a light pipe, a light tunnel, a microlens array and a diffuser.

7. The illuminator system of claim 1, further including for each UV LED light source a corresponding electronics/cooling unit configured to electrically control and cool the corresponding UV LED light source.

8. The illuminator system of claim 1, wherein the UV LED light sources have an LED emission region and further including between at least one of the UV LED light sources and the corresponding dichroic mirror a lens system configured to magnify the LED emission region.

9. A UV lithography system, comprising in order along an optical axis.
the UV illuminator system of claim 1;
a reticle stage configured to support a reticle and arranged relative to the illuminator system so that UV light from the illuminator illuminates the reticle over an imaging field;
a projection optical system arranged adjacent the reticle stage and configured to form an image of the reticle over the imaging field; and
a wafer stage configured to support a semiconductor wafer having light-sensitive surface and arranged to receive the imaging field and form therefrom at least one exposure field.

10. The UV lithography system of claim 9, wherein the reticle stage and wafer stage are configured to move relative to one another so that the exposure field is larger than the imaging field.

11. A method of forming ultraviolet (UV) illumination for a UV lithography system, comprising:
providing a plurality of light-emitting diode (LED) light sources that emit UV light;
directing the UV light to corresponding dichroic mirrors arranged relative to the LED light sources and configured to direct the UV light along a common optical path;
homogenizing the UV light with a light homogenizer having an output end and arranged along the common optical path and that acts to homogenize the UV light from the plurality of LED light sources, thereby outputting homogenized light at the output end; and
wherein the method has a collection efficiency of greater than 50% and an illumination output of equal to or greater than 850 mW/mm².

12. The method of claim 11, wherein homogenizing the UV light includes directing the light through a light pipe having dichroic mirrors are formed on angled facets of the light pipe.

13. The method of claim 11, including forming at least one of the plurality of UV LED light sources includes combining a plurality of LED elements into an LED array.

14. The method of claim 11, including forming with first, second and third UV LED light sources UV light in the following wavelength bands: Δλ₁ from 360 nm to 380 nm; Δλ₂ from 390 nm to 410 nm; and Δλ₃ from 420 nm to 450 nm.

15. The method of claim 11, wherein homogenizing the UV light includes directing the UV light from each UV LED light source with respective lenses and a bulk dichroic mirrors configured to image the UV light onto an input end of a light homogenizer.

16. The method of claim 11, further including cooling each UV LED light source.

17. The method of claim 11, wherein the UV LED light sources each have an LED emission region and further including magnifying the LED emission region.

18. The method of claim 11, further comprising forming one or more of the UV LED light sources from a plurality of LEDs arranged in an array.

19. The method of claim 18, wherein the one or more LED arrays include an emitting region and a non-emitting region, and wherein the non-emitting region is 5% or less than the emitting region.

20. The method of claim 11, further including:
irradiating with the UV illumination at least a portion of a reticle; and
forming an image of the illuminated portion of the reticle on a photosensitive surface of a semiconductor wafer.
